(19) United States
(12) Patent Application Publication
(10) Pub. No.: US 2011/0151181 A1
(43) Pub. Date: Jun. 23, 2011

(54) Fiber Enhanced Porous Substrate

(75) Inventor: James Jenq Liu, Mason, OH (US)

(73) Assignee: GEO2 TECHNOLOGIES, INC., Woburn, MA (US)

(21) Appl. No.: 12/971,479

(22) Filed: Dec. 17, 2010

Related U.S. Application Data
(60) Provisional application No. 61/288,613, filed on Dec. 21, 2009.

(51) Int. Cl. B32B 3/12; B29C 47/00

(52) U.S. Cl. 428/116; 264/630

(57) ABSTRACT

A porous honeycomb substrate having about 10% to about 60% by volume ceramic fiber is fabricated in a variety of material compositions. The fiber material is combined with particle-based materials to reaction-form composite structures forming a porous matrix. The porous honeycomb substrate exhibits an open pore network of porosity from the fiber component to provide high permeability for various applications such as filtration and catalytic hosting of chemical processes.

### CROSS-REFERENCE TO RELATED APPLICATIONS

This Application claims priority to U.S. Provisional Patent Application No. 61/288,613 filed Dec. 21, 2009, the entire disclosure of which is herein incorporated by reference.

### FIELD OF THE INVENTION

The invention is related generally to porous honeycomb substrates, and more particularly to porous honeycomb substrates composed of raw materials comprising fiber-based materials.

### BACKGROUND OF THE INVENTION

Advanced ceramic materials are commonly utilized in systems located in hostile environments, such as, for example, automotive engines (e.g., catalytic converters), aerospace applications (e.g., space shuttle titles), refractory operations (e.g., firebrick) and electronics (e.g., capacitors, insulators). Porous ceramic bodies are of particular use as filters in these environments. For example, today's automotive industry uses ceramic honeycomb substrates (i.e., a porous ceramic body) to host catalytic oxidation and reduction of exhaust gases, and to filter particulate emissions. Ceramic honeycomb substrates provide high specific surface area for filtration and support for catalytic reactions and, at the same time, are stable and substantially structurally sound at high operating temperatures associated with an automotive engine environment.

In general, ceramic materials, such as for example, aluminum titanate based ceramics, are inert materials that perform well in high temperature environments. However, ceramic materials are not immune to thermal stresses, such as those stresses generated from high thermal gradients and environments that subject the material to thermal excursions between temperature extremes. The performance of ceramic materials exposed to extreme thermal environments is even further challenged when highly porous properties are desired, such as in filtration applications. High porosity aluminum titanate substrate materials as a filtration media and/or catalytic host in high temperature environments are known to degrade and fail in many applications.

### BRIEF SUMMARY OF THE INVENTION

This invention overcomes the disadvantages of the prior art by providing a high porosity substrate from the use of fiber-based materials to provide a desired composition with mechanical integrity resulting from a rigid fibrous microstructure. The substrate of the present invention is suitable for use in rigorous environments such as high temperature environments as a filtration media and/or catalytic host.

In an aspect of the present invention a porous honeycomb substrate having a rigid honeycomb form having an array of channels. As used in this specification, the term “rigid” implies that the structure is not flexible or yielding when handled or processed, in that it exhibits a cold crush strength of at least 100 psi. The honeycomb substrate of the present invention comprises about 10% to about 60% ceramic fiber by volume, with the balance, or about 90% to about 40% by volume, a ceramic material. The ceramic fiber and the ceramic material form a composition of the porous substrate resulting from a reaction between the ceramic fiber and the ceramic material. The fiber material in the porous substrate contributes to the formation of an open pore network of porosity in the substrate, providing high permeability and low operational backpressure when adapted for a filtration application.

Methods of manufacturing the porous honeycomb substrate include mixing about 10% by volume to about 60% by volume fiber material with the balance of particle-based material to provide materials that are precursors to the desired composition of the substrate. These materials, representing the non-volatile components, are mixed with volatile components, such as binders and pore formers, with a liquid to provide an extrudable mixture. The mixture is extruded into a green honeycomb form, that is dried, and subjected to a series of heating processes to sequentially remove the volatile components and then sinter the green honeycomb form to reaction-form the precursors into the desired composition.

In an aspect of the invention, the composition that is reaction-formed between the fiber-based materials and the particle-based materials can be an interfacial layer on the fiber-based material or form on the surface of the fiber-based material or the particle-based material. In another aspect of the invention, the composition that is reaction-formed between the fiber-based materials and the particle-based materials can be substantially uniformly distributed through the substrate. In yet another aspect of the invention, the composition that is reaction-formed between the fiber-based materials and the particle-based materials can substantially consume the fiber so that the interface between the fiber material and the ceramic material is substantially indeterminate.

Aspects of the invention include material compositions that are reaction-formed between the fiber materials and the particle-based materials include, without limitation, aluminum titanate, cordierite, and silicon carbide.

### BRIEF DESCRIPTION OF THE SEVERAL VIEWS OF THE DRAWINGS

The drawings constitute a part of this specification and include exemplary embodiments of the invention, which may be embodied in various forms.

FIG. 1 depicts a honeycomb substrate according to the present invention.

FIG. 2 illustrates an enlarged area of the porous microstructure of the honeycomb substrate of the present invention.

FIG. 3 is a flowchart describing a method of fabricating a porous honeycomb substrate according to the present invention.

### DETAILED DESCRIPTION OF THE INVENTION

Detailed descriptions of examples of the invention are provided herein. It is to be understood, however, that the present invention may be exemplified in various forms. Therefore, the specific details disclosed herein are not to be interpreted as limiting, but rather as a representative basis for teaching one skilled in the art how to employ the present invention in virtually any detailed system, structure, or manner.

Ceramic fiber-based substrate materials are useful for high temperature insulation, filtration, and for hosting catalytic reactions. The materials, in any of a variety of forms, can be used in high temperature applications as catalytic converters, NOx adsorbers, DeNox filters, multi-functional filters, molten metal transport mechanisms and filters, regenerator cores, chemical processes, fixed-bed reactors, hydrodesulfurization, hydrocracking or hydrotreating, and engine exhaust filtration.

Powder-based ceramic substrates can be fabricated in a porous form through the use of organics and pore formers that are volatized during the sintering process that is typically performed in the fabrication of the substrate. Alternatively, the sintering process for powder-based ceramic honeycomb substrates can result in a densification of the ceramic precursors, resulting in the inclusion of pores and void space throughout the sintered substrate material. The porous substrate fabricated from powder-based materials is significantly compromised when the bulk porosity of the sintered material exceeds 50%. At these high levels of porosity, the powder-based substrate becomes much weaker and becomes subject to mechanical failure when subjected to temperature gradients and/or mechanical stress. Additionally, the pore morphology of a porous ceramic substrate derived from powder-based ceramic and ceramic precursors is not optimized for filtration applications as the void space and pores caused from densification of the raw materials and/or through the volatization of organics and pore formers in a powder-based material is not well interconnected. An open-pore network, or pore space that is well interconnected exhibits high levels of permeability which results in improved flowrates with lower backpressure and greater efficiency in a filtration application.

Porous ceramic substrates derived from fiber-based raw materials can provide a highly permeable type of porosity with improved structural integrity. Fiber-based materials are known to provide high strength at low mass, and can survive wide and sudden temperature excursions without exhibiting thermal shock or mechanical degradation. Ceramic fibers can also be used to fabricate high temperature rigid insulation panels, such as vacuum cast boards used for lining combustion chambers and high temperature environments that require impact resistance. Casting processes can also be used to form rigid structures of ceramic fibers such as kiln furniture and setter tiles.

As used herein a fiber is a form of material where the aspect ratio, i.e., length divided by width, is greater than one. The cross section of a fiber is commonly circular in shape, though other cross sectional shapes such as triangular, rectangular, or polygonal, are possible. Additionally, the width of the fiber may be variable over the length of the fiber or fiber section. Material compositions of many types can be provided in a fiber form. Generally a fiber is produced by any one of a number of processes, including without limitation, spun, blown, drawn, or sol-gel processes. most ceramic fibers used for refractory insulation, such as aluminosilicate or alumina fibers, have a diameter or width of about 1 micron to about 25 microns, and more typically, 3 microns to about 10 microns. One skilled in the art will appreciate that the shape of fibers a a raw material for the production of porous fibrous substrates is in sharp contrast to the more typical ceramic powder materials, where the aspect ratio of such particle-based material is approximately one.

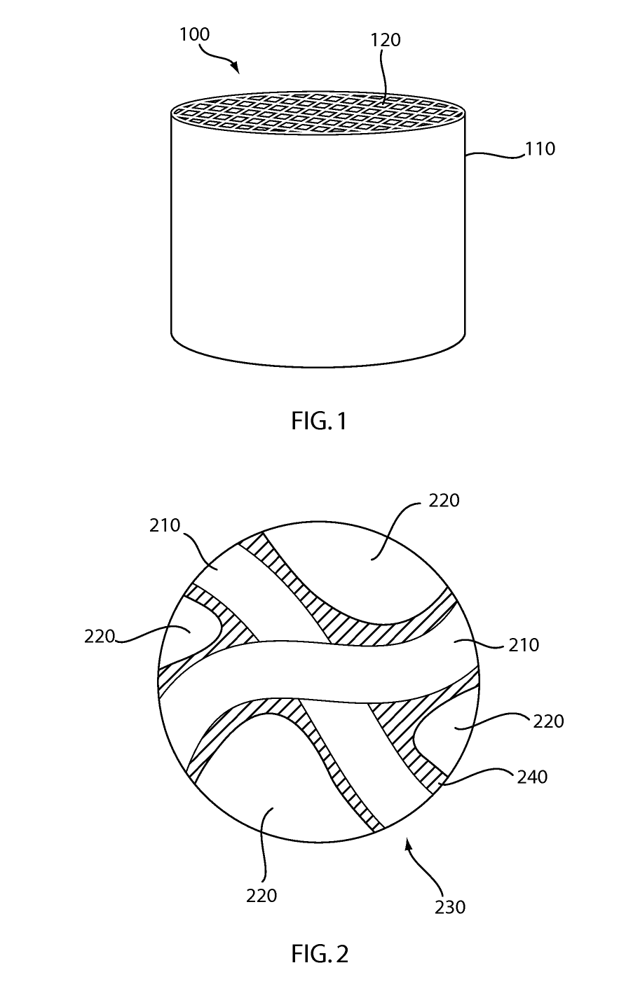

FIG. 1 depicts a honeycomb substrate according to the present invention. The substrate 100 has a honeycomb array of walls 110 defining channels 120 between adjacent walls. The substrate 100 and more particularly, the walls 110, are compose of a porous microstructure of a ceramic material composition. Referring to FIG. 2 a cross-section of the porous substrate according to the present invention, showing a porous ceramic material comprising fibers to provide a porous microstructure 200 is illustrated. Pore space 220 is created from space between overlapping and inter-tangled fibers 210. The matrix 230 forming the structure of the porous material of the walls 110 is formed from the fibers 210 and ceramic material 240.

The use of fiber to strengthen articles is generally known in the art. Common fiber reinforced composites comprise a structure of fibers and a matrix. The fibers provide strength while the matrix glues the fibers together to transfer stress between the reinforcing fibers. Honeycomb ceramic substrates have been known to include small amounts of fibers to provide strengthening and reinforcement of the honeycomb structure. In the method and apparatus of the present invention, however, the fibers are not merely strengthening the matrix, but rather reacting with and contributing to the formation of the matrix, with porosity and permeability of the substrate resulting from space between adjacent and overlapping fibers. A key distinction between the structure of the present invention and that of a fiber-reinforced article is that the fibers of the present invention react with adjacent and adjoining fibers and/or with the bonding matrix to form a generally homogeneous composite material.

Fiber-based materials as a raw material for the fabrication of porous honeycomb substrates provides improved properties over powder-based materials of the same composition. Commonly owned U.S. Pat. Nos. 7,486,962 and 7,578,865, incorporated herein by reference, disclose methods and apparatus of highly porous fiber-based honeycomb substrates. These references disclose the open pore network and interconnected porosity of extruded honeycomb substrates resulting from intertangled and bonded fibers that provides a highly permeable porous structure that is advantageous in filtration and chemical processing applications. When fiber-based materials are included in an extrudable mixture of ceramic materials and ceramic precursors and/or glass materials with organic binders and pore formers, the fiber-based materials are prepositioned relative to the organic binder and pore formers during the extrusion process forming the honeycomb form to influence the size, shape, and distribution of interconnected pores. The elongated fiber material provides a path between adjacent pores to ensure interconnectivity between the adjacent pores in the final sintered structure.

The porosity of a fiber-based porous substrate is largely determined by the relative quantity of volatile components to non-volatile components in the batch material used to form the honeycomb substrate. For example, in a porous substrate having approximately 60% porosity, the extrudable batch material will likely contain approximately 40% by volume non-volatile components and approximately 60% volatile components. Non-volatile components include the materials that result in the formation of the matrix 230, and the volatile components include the materials that are volatized during the processes subsequent to the extrusion formation processes, including binders, pore former, and liquids. The volatile components can include fiber-based materials, such as fugitive fibers that act as pore forming materials, such as paper or wood pulp fiber or carbon fiber. However, fiber materials having an organic composition can also be considered non-volatile materials if the processes subsequent to the extrusion formation processes are configured to react these materials to be part of the matrix 230, such as if the sintering process is conducted in a vacuum or inert environment and the matrix 230 comprises carbide-based compositions.

In the porous structure according to the present invention as shown in FIG. 2, the relative quantity of fiber-based materials is approximately 10% to 60% by volume of the non-volatile components used to form the matrix 230. The relative quantity of fiber-based materials can be 10%, 15%, 20%, 25%, 30%, 35%, 40%, 45%, 50%, 55%, or 60% by volume of the non-volatile components used to form the matrix 230. The fiber reacts with the remaining 40% to 90% particle-based material to provide the desired composition and/or to form a composite structure having a generally uniform composition in the matrix 230. This relative quantity of fiber is generally low in the sense that the fiber material may or may not be readily apparent in the final structure without detailed micro-structural analysis. However, the use of the fiber-based material influences the pore structure of the resulting matrix 230 while contributing to the composition, and thus, the properties of the material during the formation of the substrate.

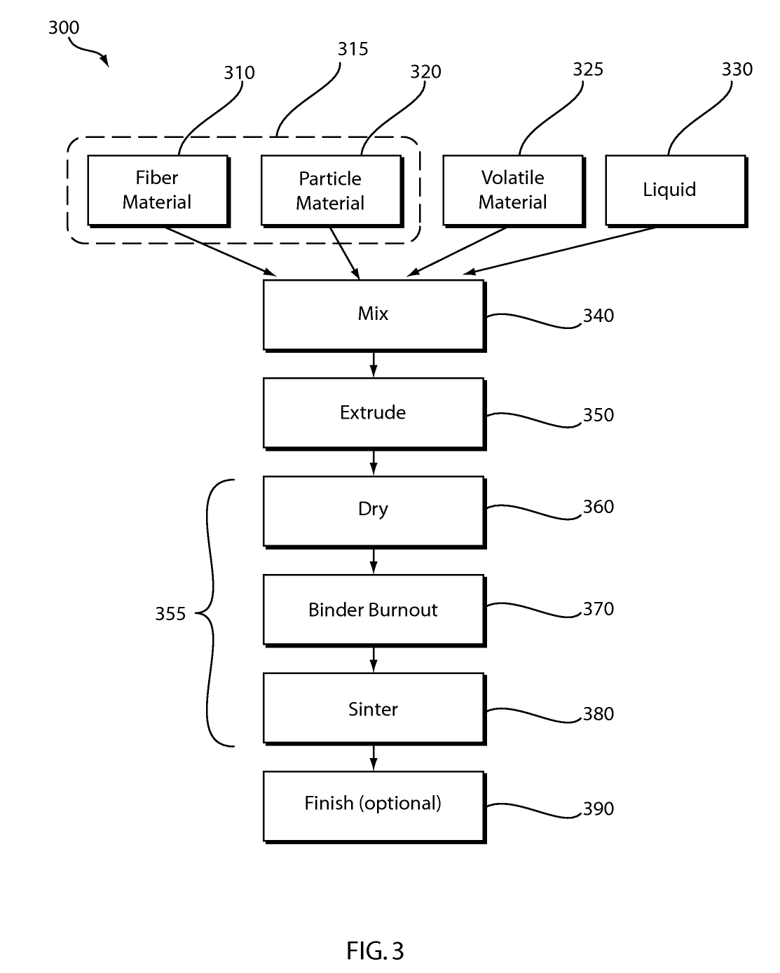

FIG. 3 depicts a process for fabricating the porous structure of the present invention. Generally, the method 300 uses an extrusion process to extrude a green substrate that can be cured into the final porous substrate. The extrusion process of the method 300 provides flexibility in the size, shape, and geometry of the substrate, in that the extrusion dies and extrusion equipment can be adapted for a particular configuration.

Generally, non-volatile components 315 (comprising fiber materials 310 and particles 320) are mixed with volatile components 325 (comprising binders and/or pore formers), and a liquid 330 at a mixing step 340. The fiber materials 310 include ceramic or glass materials that are precursors to the desired composition of the final substrate or having the composition of the final substrate or a component to the composite material of the final substrate. The particle materials include ceramic or glass materials that are precursors to the desired composition of the final substrate or having the composition of the final substrate or a component to the composite material of the final substrate. According to the present invention, the relative amount of fiber material 310 can be in the range of about 10% by volume to about 60% by volume of the non-volatile components 315. The composition of the fiber materials 310 and the composition of the particle materials 315 determine the composition of the final substrate, and particularly, the matrix 230.

For example, to fabricate a porous substrate having an aluminum titanate composition, the non-volatile components 315 can include aluminum titanate precursors or additional compounds that may result in non-stoichiometric aluminum titanate. For example, aluminosilicate materials, such as an amorphous 50% alumina/50% silicon dioxide (silica), is readily available in fiber form, that can be combined with powdered titanium dioxide to form a structure having a composite composition of aluminum titanate and mullite and/or aluminum titanate, mullite and a silica-based glass. Further still, mullite fiber can be included with titanium dioxide fiber to provide a similar aluminum titanate-mullite-glass composite. In another embodiment, the precursors can be in powder (and/or colloidal) form, with the additives comprising silica fiber, to form an aluminum titanate structure around the silica fiber, or alternatively, a mullite fiber that was formed from a reaction of appropriate quantities of alumina from the precursors with the silica fiber. These composite structures can be in the form of an aluminum titanate coating that is formed on the fiber additive. Specific examples of various embodiments are provided herein below.

According to the present invention, the fiber material 210 can include any ceramic, glass, inorganic, organic, metallic, or intermetallic fiber material. For example, the fiber 310 can include compositions of mullite, alumina, silica/blends of alumina and silica, blends of alumina, silica and aluminosilicate, aluminoborosilicate, silicon carbide, silicon nitride, cordierite, yttrium aluminum garnet, alumina-enhanced thermal barrier (AETB) compositions, alumina-silica-boria compounds, combinations of alumina, silica, boria, and/or aluminoborosilicates, alumina-mullite, alumina-silica-zirconia, alumina-silica-chromia, magnesium-silicate, magnesium strontium silicate, magnesium calcium strontium silicate, fiberglass, e-glass, aluminum titanate fiber, strontium titanium oxide, titania fiber, titanium carbide fiber, calcium aluminosilicate, polyester fibers, carbon fibers, yttrium nickel garnett, FeCrAl alloys, phenolic fibers, polymeric fibers, cellulose, keratin, para-aramid synthetic fiber, nylon, polytetrafluoroethylene, fluoropolymers, biaxially-oriented polyethylene terephthalate polyester, zircon fibers, nickel, copper, brass, stainless steel, nickel chromium, Ni₃Al, or whiskers such as Al₂O₃ whiskers, MgO whiskers, MgO—Al₂O₃ whiskers, Fe₂O₃ whiskers, BeO whiskers, MoO whiskers, NiO whiskers, Cr₂O₃ whiskers, ZnO whiskers, Si₃N₄ whiskers, AlN whiskers, ZnS whiskers, CdS whiskers, tungsten oxide whiskers, LaB₆ whiskers, CrB whiskers, SiC whiskers, and B₄C whiskers.

The volatile components 325 include binders, dispersants, pore formers, plasticizers, processing aids, and strengthening materials. Binders include organic and inorganic materials and extrusion or forming aids, rheology modifiers and processing aids and plasticizers that may be useful during the subsequent extrusion step 350. For example, organic binders that can be included as volatile components 325 include methylcellulose, hydroxypropyl methylcellulose (HPMC), ethylcellulose and combinations thereof. Organic binders can include, without limitation, thermoplastic resins, such as: polyethylene; polypropylene; polybutene; polystyrene; polyvinyl acetate; polyester; isotactic polypropylene; atactic polypropylene; polysulphone; polyacetal polymers; polymethyl methacrylate; fumaron-indane copolymer; ethylene vinyl acetate copolymer; styrene-butadiene copolymer; acryl rubber; polyvinyl butyral; and inomer resin. Organic binders can include, without limitation, thermosetting binders, such as: epoxy resin; nylon; phenol formaldehyde; and phenol furfural; waxes; paraffin wax; wax emulsions; and microcrystalline wax. Organic binders can also include, without limitation, celluloses; dextrines; chlorinated hydrocarbons; refined alginates; starches; gelatins; lignins; rubbers; acrylics; bitumens; casein; gums; albumins; proteins; and glycols. The volatile components 325 may typically include sintering aids, in relatively small amounts, such as less than 1% by weight, such as magnesium carbonate, or others, to promote the formation of aluminum titanate at lower sintering temperatures, without significantly altering the properties of the resulting aluminum titanate composition, such as, for example, the CTE. The volatile components 325 can also include stabilizing compounds that inhibit the potential for decomposition of the aluminum titanate material during operation, for example, as a diesel particulate filter. Stabilizing compounds can include trace quantities of silica, magnesium oxide, and/or iron oxide. Water soluble binders can be included as volatile components 325, including, for example: hydroxypropyl methyl cellulose; hydroxyethyl cellulose; methyl cellulose; sodium carboxymethyl cellulose; polyvinyl alcohol; polyvinyl pyrrolidone; polyethylene oxide; polyacrylamides; polyethyterimine; agar; agarose; molasses; dextrines; starch; lignosulfonates; lignin liquor; sodium alginate; gum arabic; xanthan gum; gum tragacanth; gum karaya; locust bean gum; irish moss; scleroglucan; acrylics; and cationic galactomanan.

Inorganic binders can be included as particle materials 320, such as, for example: soluble silicates; soluble aluminates; soluble phosphates; ball clay; kaolin; bentonite; colloidal silica; colloidal alumina; and borophosphates. These inorganic binders provide plasticity and extrudability, and also contribute to the formation of a composite structure as non-volatile components 315.

Volatile components 325 can also include plasticizers, that may include, without limitation: stearic acid; polyethylene glycol; polypropylene glycol; propylene glycol; ethylene glycol; diethylene glycol; triethylene glycol; tetraethylene glycol; dimethyl phthalate; dibutyl phthalate; diethyl phthalate; dioctyl phthalate; diallyl phthalate; glycerol; oleic acid; butyl stearate; microcrystalline wax; paraffin wax; japan wax; carnauba wax; bees wax; ester wax; vegetable oil; fish oil; silicon oil; hydrogenated peanut oil; tritolyl phosphate; glycerol monostearate; and organo silane.

Volatile components 325 can also include pore formers that enhance the size and distribution of pores in the porous substrate 100. Pore formers are added to increase open space in the final porous substrate. Pore formers are selected not only for the ability to create open space and based upon their thermal degradation behavior, but also for assisting in orienting the fibers during mixing and extrusion. In this way, the pore formers assist in arranging the fibers into an overlapping pattern to facilitate proper bonding between fibers during later stages of the sintering step 380. Additionally, pore formers may also play a role in the alignment of the fibers in preferred directions, which effect the thermal expansion characteristics of the extruded substrate along different axes. Pore formers as volatile components 325 can include, without limitation: carbon black; activated carbon; graphite flakes; synthetic graphite; wood flour; modified starch; starch; celluloses; coconut shell flour; husks; latex spheres; bird seeds; saw dust; pyrolyzable polymers; poly(alkyl methacrylate); polymethyl methacrylate; polyethyl methacrylate; poly n-butyl methacrylate; polyethers; poly tetrahydrofuran; poly(1,3-dioxolane); poly(alkalene oxides); polyethylene oxide; polypropylene oxide; methacrylate copolymers; polyisobutylene; polytrimethylene carbonate; poly ethylene oxalate; poly beta-propiolactone; poly delta-valerolactone; polyethylene carbonate; polypropylene carbonate; vinyl toluene/alpha-methylstyrene copolymer; styrene/alpha-methyl styrene copolymers; and olefin-sulfur dioxide copolymers.

As briefly described above, one or more fiber compositions can be included as fiber materials 310. Additionally, volatile components 325 can be in powder, liquid solution or fiber form.

The liquid 330 is typically water, though other liquids, such as solvents can also be provided. Additionally, the non-volatile components 315 and volatile components 325 can be provided in a colloidal suspension or solution, that may reduce or eliminate the amount of additional liquid 330 that may be required. The liquid 330 is added as needed to attain a desired rheology of the mixture suitable for the extrusion step 350. Rheological measurements can be made during the mixing step 340 to evaluate the rheology of the mixture compared with a desire rheology for the extrusion step 350. Excess liquid 330 may not be desirable in that excessive shrinking may occur during the curing step 355 that may induce the formation of cracks in the substrate.

The non-volatile components 315 and volatile components 325 and fluid 330 are mixed in the mixing step 340 to provide an extrudable mixture. The mixing step 340 may include a dry mix aspect, a wet mix aspect, and a shear mix aspect. It has been found that shear or dispersive mixing is desirable to produce a highly homogenous distribution of fibers within the mixture. This distribution is particularly important due to the relatively low concentration of ceramic material in the mixture. Shear mixing is necessary to break up and distribute the fibers within the mixture. A sigma mixer, or equivalent equipment, is suitable for performing the mixing step 340. As the homogeneous mixture is being mixed, the rheology of the mixture may be adjusted as necessary. As the mixture is mixed, its rheology continues to change. The rheology may be subjectively tested, or it may be measured to comply with rheological values known to those skilled in the art.

The extrudable mixture is then extruded into a green substrate at extrusion step 350. In the case of screw extruders, the mixing step 340 can be performed nearly contemporaneously as the extrusion step 360 to provide a continuous in-line processing at high volume. Alternatively, a batch process in a piston extruder can also be performed to extrude the mixture into a green substrate. A honeycomb form can be attained by extruding the mixture through a honeycomb extrusion die. The honeycomb cell size and geometry, such as cell density and wall thickness, is determined by the extrusion die design. The green substrate has sufficient green strength to support the substrate and maintain the extruded shape and form for subsequent processing.

The curing sequence 355 consists essentially of a drying step 360, a binder burnout step 370 and a sintering step 380. The drying step 360 is performed to remove substantially all the liquid in the green substrate, and to solidify or gelate the binder component of the volatile components 325. The drying step 360 may be typically performed at relatively low temperatures in an oven, or alternative drying methods can be employed, such as microwave, infrared, or controlled humidity drying systems. It has been shown that drying the green substrates in an infrared or microwave drying oven to remove more than 98% of the fluid, such as water, is an acceptable to the extent that cracking or failures from rapid shrinkage in subsequent high temperature processing is reduced or eliminated.

The binder burnout step 370 is performed to remove the volatile components 325 that are at least partially volatile at elevated temperatures, such as organic materials. These additives can be burned off in a controlled manner to maintain the alignment and arrangement of the fiber, and to ensure that escaping gas and residues do not interfere with the fiber structure. As the additives burn off, the fiber materials 310 maintain their position relative to the particle materials 320 within the structure. The fibers have been positioned into these overlapping arrangement using the binder, for example, and may have particular patterns formed through the use of any pore former materials. The specific timing and temperature, and environment to remove the volatile components 325 during the binder burnout step 370 depends on the materials selected. For example, if HPMC is used as a volatile component 325 for an organic binder with graphite particles as a pore former, the binder burnout step 370 can selectively remove the additives by heating the green substrate to approximately 325° C. to thermally disintegrate the HPMC, and then heating the green substrate to approximately 600° C. in an environment purged with air to oxidize the graphite into carbon dioxide.

The sintering step 380 is then performed to form the composition of the porous structure from the non-volatile components 315 including the fiber materials 310. In this sintering step 380, the fiber-based materials 310 may have been aligned and positioned from the extrusion process 350, with the volatile components 325 removed from the binder burnout step 370. Referring back to FIG. 2, the fiber based materials 310 are represented as fibers 210, with the open pore space 220 formed from the volatile components 325 that had been removed in the binder burnout step 370, with the powder-based materials 320 at least partially surrounding the fibers. The sintering step 380 heats the substrate to a temperature in an environment sufficient to sinter together the non-volatile components 315 into the composite structure of the matrix 230.

In an embodiment of the invention, the fiber material 310 in a relative quantity of about 10% to about 60% by volume bonds to the particle-based materials 320 in a relative quantity of about 90% to about 40% by volume to form a composite with generally distinct compositional differentiation between the fiber and non-fiber materials in the composite. In this embodiment, the reaction between the fiber and the non-fiber materials creates an interfacial composition at the fiber/non-fiber interface during the sintering step 380. Alternatively, the reaction between the fiber and the non-fiber materials modifies the surface of the fiber material and/or the non-fiber material in the matrix 320. Examples of this embodiment can include mullite fiber in a matrix of cordierite formed from cordierite precursors including magnesium oxide, alumina and silica as the particle-based material 320. An alternate example can include aluminosilicate fiber in a matrix of aluminum titanate formed from alumina powder and titanium dioxide powder as the particle based material 320. Yet another alternate example is aluminum titanate forming on aluminosilicate or mullite fiber. Illustrative examples are herein provided.

In an alternate embodiment of the invention, the fiber material 310 in a relative quantity of about 10% to about 60% by volume completely reacts with the particle-based materials 320 in a relative quantity of about 90% to about 40% by volume to form a composition where there is no discernable distinction between the fiber material 310 and the surrounding particle-based material 320 in the matrix 230. In this embodiment, the fiber material 310 participates in a thermo-chemical reaction during the sintering step 380 to form a material having the desired composition. Examples of this embodiment can include aluminosilicate fiber combined with magnesium oxide, alumina and silica in appropriate quantities to create a cordierite composition. An alternate example can include carbon fiber with graphite particles and silicon particles in appropriate relative quantities to create a silicon carbide composition. Similarly, alumina fiber with titanium oxide powder in appropriate relative quantities can be used to create a porous substrate having an aluminum titanate composition. Illustrative examples are herein provided.

In yet another embodiment of the invention, the fiber material 310 in a relative quantity of about 10% to about 60% by volume partially reacts with the particle-based materials 320 in a relative quantity of about 90% to about 40% by volume to form a composite composition where there is a distinction between the fiber material 310 and the particle-based material 320 in the matrix 230, but the fiber material at least partially reacts with the surrounding ceramic material 240 to form a composite structure. Examples of this embodiment can include aluminosilicate fiber combined with magnesium oxide, alumina and silica in appropriate quantities to create ceramic material 340 in a cordierite composition with mullite fiber. An alternate example can include alumina fiber with titanium oxide powder in appropriate relative quantities can be used to create a porous substrate having a composite structure of ceramic material 240 having an aluminum titanate composition with alumina fiber. Illustrative examples are herein provided.

Aluminum titanate (Al₂TiO₅) is an orthorhombic crystal structure that forms a stable microcracked structure in sintered polycrystal or amorphous materials. Aluminum titanate is a stable oxide ceramic material that is highly regarded for exhibiting excellent thermal shock resistance, due to an extremely low coefficient of thermal expansion (CTE). Ceramic materials with a low CTE are desirable in applications where thermal gradients may exist. For example, in a diesel particulate filter, a thermal gradient can form when the soot accumulated in the filter is periodically regenerated. Regeneration of a diesel particulate filter involves burning off accumulated soot to oxidize the accumulated soot into carbon dioxide and water vapor. Thermal gradients in excess of 800 degrees Celsius in a filter can develop, which can induce thermal stress that could exceed the strength of the ceramic material. When a material having a low CTE is used, the resulting thermal stresses from high thermal gradients can be reduced accordingly.

Porous honeycomb substrates composed of aluminum titanate are previously known to be fabricated using powder-based raw materials. The effective range of porosity is limited as the aluminum titanate substrate from powder-based materials becomes mechanically weak when porosity exceeds approximately 50%. A porous aluminum titanate substrate according to the present invention, that is fabricated using fiber-based raw materials, using extrusion methods to produce a honeycomb substrate, can provide a porous aluminum titanate honeycomb substrate having a porosity of 50% or greater, with sufficient mechanical strength and other thermal and mechanical properties. Furthermore, about 10% to about 40% by volume of fiber-based raw materials with the balance of particle-based materials used to fabricate a honeycomb form can result in a preferred orientation of the fiber—i.e., fibers aligned in the extrusion direction. In so doing, the fiber alignment (which can be controlled or influenced by the mechanical properties of the fiber raw materials, such as strength resulting from diameter, length, and composition), can impart anisotropic CTE characteristics, including low CTE properties in the direction of the substrate that may experience the largest thermal gradients in operation.

### EXAMPLES

The following examples are provided to further illustrate and to facilitate the understanding of the disclosure. These specific examples are intended to be illustrative of the disclosure and are not intended to be limiting.

In a first illustrative example approximately 11% by volume fiber material is mixed with approximately 89% by volume particle-based material to fabricate a porous honeycomb substrate having an aluminum titanate composition. In this example, 15 grams of mullite fiber (bulk fiber having a diameter of approximately 4-8 microns) with 40 grams of titanium dioxide powder and 51 grams of alumina powder as the non-volatile components. The non-volatile components were mixed with 16 grams hydroxypropyl methylcellulose (HPMC) as an organic binder and 65 grams graphite particles (−325 mesh grade) as a pore former, together representing the volatile components and 65 grams deionized water as the fluid. An extrudable mixture was prepared and formed into a 1″ diameter honeycomb by extrusion. The green substrates were dried using a radio-frequency (RF) dryer, followed by a binder burnout step at 325° C. for approximately one hour with a nitrogen purge to decompose the organic binder, and 1,000° C. for approximately four hours with an air purge to burn out the graphite pore former. The material was then sintered at 1,400° C. for two hours to form the porous substrate. Analysis of the porous substrate determined the substrate to have a composition of approximately 87% aluminum titanate, with the balance of the composition including mullite, rutile (titanium dioxide) and other amorphous materials. The porosity was measured to be 57.2% with a cold crush strength of 552 psi.

In a second illustrative example, the same materials of the first illustrative example (11% fiber by volume) were prepared, but sintered at 1,500° C. for two hours, to provide for more of the fiber material to react with the particle-based materials, to provide a substrate having a porosity of 48.8% with a cold crush strength of 1,277 psi.

In a third illustrative example approximately 13% by volume fiber material is mixed with approximately 87% by volume particle-based material to fabricate a porous honeycomb substrate having an aluminum titanate composition. In this example, 20 grams of mullite fiber (bulk fiber having a diameter of approximately 4-8 microns) with 40 grams of titanium dioxide powder and 60 grams of alumina powder as the non-volatile components. The non-volatile components were mixed with 16 grams hydroxypropyl methylcellulose (HPMC) as an organic binder and 65 grams graphite particles (−325 mesh grade) as a pore former, together representing the volatile components and 70 grams deionized water as the fluid. An extrudable mixture was prepared and formed into a 1″ diameter honeycomb by extrusion. The green substrates were dried using a radio-frequency (RF) dryer, followed by a binder burnout step at 325° C. for approximately one hour with a nitrogen purge to decompose the organic binder, and 1,000° C. for approximately four hours with an air purge to burn out the graphite pore former. The material was then sintered at 1,400° C. for two hours to form the porous substrate. Analysis of the porous substrate determined the substrate to have a composition of approximately 91% aluminum titanate, with the balance of the composition including mullite, rutile (titanium dioxide) and other amorphous materials.

In a fourth illustrative example approximately 14% by volume fiber material is mixed with approximately 86% by volume particle-based material to fabricate a porous honeycomb substrate having an aluminum titanate composition. In this example, 20 grams of mullite fiber (bulk fiber having a diameter of approximately 4-8 microns) with 40 grams of titanium dioxide powder and 51 grams of alumina powder as the non-volatile components. The non-volatile components were mixed with 16 grams hydroxypropyl methylcellulose (HPMC) as an organic binder and 65 grams graphite particles (−325 mesh grade) as a pore former, together representing the volatile components and 70 grams deionized water as the fluid. An extrudable mixture was prepared and formed into a 1″ diameter honeycomb by extrusion. The green substrates were dried using a radio-frequency (RF) dryer, followed by a binder burnout step at 325° C. for approximately one hour with a nitrogen purge to decompose the organic binder, and 1,000° C. for approximately four hours with an air purge to burn out the graphite pore former. The material was then sintered at 1,500° C. for two hours to form the porous substrate. Analysis of the porous substrate determined the substrate to have a composition of approximately 82.9% aluminum titanate, with the balance of the composition including mullite, rutile (titanium dioxide) and other amorphous materials. The porosity was measured to be 48.8% with a cold crush strength of 1,277 psi.

In a fourth illustrative example approximately 56% by volume fiber material is mixed with approximately 44% by volume particle-based material to fabricate a porous honeycomb substrate having an aluminum titanate composition. In this example, 50 grams of alumina fiber (bulk fiber having a diameter of approximately 10 microns) with 30 grams of titanium dioxide powder and trace amounts of magnesium carbonate and iron oxide as the non-volatile components. The non-volatile components were mixed with 16 grams hydroxypropyl methylcellulose (HPMC) as an organic binder and 65 grams graphite particles (−325 mesh grade) as a pore former, together representing the volatile components and 70 grams deionized water as the fluid. An extrudable mixture was prepared and formed into a 1″ diameter honeycomb by extrusion. The green substrates were dried using a radio-frequency (RF) dryer, followed by a binder burnout step at 325° C. for approximately one hour with a nitrogen purge to decompose the organic binder, and 1,000° C. for approximately four hours with an air purge to burn out the graphite pore former. The material was then sintered at 1,550° C. for six hours to form the porous substrate. Analysis of the porous substrate determined the substrate to have a composition of approximately 85% aluminum titanate, with the balance of the composition including mullite, rutile (titanium dioxide) and other amorphous materials. The porosity was measured to be 25.4% with a cold crush strength of 2,528 psi.

In a fifth illustrative example approximately 59% by volume fiber material is mixed with approximately 41% by volume particle-based material to fabricate a porous honeycomb substrate having an aluminum titanate composition. In this example, 25 grams of mullite fiber (bulk fiber having a diameter of approximately 4-8 microns) and 25 grams alumina fiber (bulk fiber having a diameter of approximately 10 microns) with 29 grams of titanium dioxide powder and 4 grams of alumina powder with trace amounts of strontium carbonate and magnesium carbonate as the non-volatile components. The non-volatile components were mixed with 16 grams hydroxypropyl methylcellulose (HPMC) as an organic binder and 65 grams graphite particles (−325 mesh grade) as a pore former, together representing the volatile components and 80 grams deionized water as the fluid. An extrudable mixture was prepared and formed into a 1″ diameter honeycomb by extrusion. The green substrates were dried using a radio-frequency (RF) dryer, followed by a binder burnout step at 325° C. for approximately one hour with a nitrogen purge to decompose the organic binder, and 1,000° C. for approximately four hours with an air purge to burn out the graphite pore former. The material was then sintered at 1,400° C. for six hours to form the porous substrate. Analysis of the porous substrate determined the substrate to have a composition of approximately 72% aluminum titanate, with the balance of the composition including mullite, corundum (alumina), strontium aluminosilicate and other amorphous materials. The porosity was measured to be 54.5% with a cold crush strength of 1106 psi.

Referring back to FIG. 3, the finishing step 390 can be optionally performed to configure the porous substrate for its intended application. The finishing step 390 can include plugging alternate cells of the honeycomb substrate to configure the substrate as a wall-flow filter. Additionally, the substrate can be cut or ground into a geometric shape for its intended purpose, such as a rectangular or cylindrical cross-section. In some applications, it may be desirable to assemble a large substrate from a number of smaller segments by gluing a plurality of segments using a high temperature adhesive material. Additionally, an outer skin or coating can be applied to attain a desired finished size and surface condition. The finished porous substrate can be inserted into a metal sleeve or can to provide a housing in an emission control device, such as, for example, a diesel particulate filter. One skilled in the art will appreciate other applications to which a high porosity honeycomb substrate having the characteristics and features described herein can be adapted for use.

The foregoing has been a detailed description of illustrative embodiments of the invention. Various modifications and additions can be made without departing from the spirit and scope if this invention, and each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. For example, where fiber materials and other additives are provided to the mixture, various compositions and composites can be formed including aluminum titanate, cordierite, silicon carbide, and others. In addition, further modifications to the drying, binder burnout and/or sintering steps may be implemented in conjunction with adjustments to the mixture constituents contemplated herein. Also while the variation of relative quantities of fiber materials and particle-based materials are provided, the relative quantity of fiber materials in the sintered substrate be taken broadly to include any fiber composite honeycomb structure, including, without limitation, glass bonded, glass-ceramic bonded, and ceramic bonded ceramic fiber materials. Accordingly, this description is meant to be taken only by way of example, and not to otherwise limit the scope of this invention.

What is claimed is:

1. A porous honeycomb substrate comprising:
a rigid honeycomb form having an array of channels;
ceramic fiber in about 10% to about 60% by volume;
ceramic material in about 90% to about 40% by volume;
the ceramic fiber and the ceramic material forming a composition resulting from a reaction between the ceramic fiber and the ceramic material; and
an open pore network of porosity in the substrate.

2. The porous honeycomb substrate according to claim 1 wherein the composition resulting from a reaction between the ceramic fiber and the ceramic material is at least one of an interfacial layer and a surface layer on the ceramic fiber.

3. The porous honeycomb substrate according to claim 1 wherein the composition resulting from a reaction between the ceramic fiber and the ceramic material is substantially uniformly distributed through the substrate.

4. The porous honeycomb substrate according to claim 1 wherein the composition resulting from a reaction between the ceramic fiber and the ceramic material substantially consumes the ceramic fiber.

5. The porous honeycomb substrate according to claim 1 wherein the composition resulting from a reaction between the ceramic fiber and the ceramic material is aluminum titanate.

6. The porous honeycomb substrate according to claim 1 wherein the composition resulting from a reaction between the ceramic fiber and the ceramic material is cordierite.

7. The porous honeycomb substrate according to claim 1 wherein the composition resulting from a reaction between the ceramic fiber and the ceramic material is silicon carbide.

8. A porous honeycomb substrate comprising:
a substantially rigid honeycomb form having an array of channels, the honeycomb form produced by a process comprising;
mixing about 10% to about 60% by volume fiber material with a balance of particle based material, to provide materials being precursors to a composition of the porous honeycomb substrate;
mixing the precursors with additives comprising a binder and a liquid to provide an extrudable batch;
extruding the extrudable batch into a green honeycomb form;
drying the green honeycomb form to remove substantially all the liquid;
heating the green honeycomb form to remove substantially all the binder;
sintering the green honeycomb form to reaction-form the precursors into the desired composition.

9. The porous honeycomb substrate according to claim 8 wherein the desired composition is at least one of an interfacial layer and a surface layer on the ceramic fiber.

10. The porous honeycomb substrate according to claim 8 wherein the desired composition is substantially uniformly distributed through the substrate.

11. The porous honeycomb substrate according to claim 8 wherein the step of sintering to reaction-form the precursors into the desired composition substantially consumes the ceramic fiber.

12. The porous honeycomb substrate according to claim 8 wherein the desired composition is aluminum titanate.

13. The porous honeycomb substrate according to claim 8 wherein the desired composition is cordierite.

14. The porous honeycomb substrate according to claim 8 wherein the desired composition is silicon carbide.

15. A method of fabricating a porous honeycomb substrate comprising:
mixing about 10% to about 60% by volume fiber material with a balance of particle based material, to provide materials being precursors to a composition of the porous honeycomb substrate;
mixing the precursors with additives comprising a binder and a liquid to provide an extrudable batch;
extruding the extrudable batch into a green honeycomb form;
drying the green honeycomb form to remove substantially all the liquid;
heating the green honeycomb form to remove substantially all the binder;
sintering the green honeycomb form to reaction-form the precursors into the desired composition.

16. The method according to claim 15 wherein the fiber material comprises at least one of alumina fiber, aluminosilicate fiber, and mullite fiber, and the composition is aluminum titanate.

17. The method according to claim 16 wherein the particle-based material comprises at least one of titanium dioxide and alumina.

18. The method according to claim 15 wherein the additives further comprise a pore former.

19. The method according to claim 15 wherein the fiber material comprises carbon fiber and the composition is silicon carbide.

20. The method according to claim 15 wherein the fiber material comprises at least one of alumina, silica, aluminosilicate, mullite, and magnesium aluminosilicate, and the composition is cordierite.
